(19) United States
(12) Patent Application Publication
(10) Pub. No.: US 2005/0175774 A1
(43) Pub. Date: Aug. 11, 2005

(54) Synthesis of inverted titania photonic crystal

(76) Inventor: Julia Exir, Toronto (CA)

Correspondence Address: JULIA EXIR, P.O. Box 17008, 69 Yonge Street, Toronto, ON, MSE IY2, CA

(21) Appl. No.: 10/773,401

(22) Filed: Feb. 9, 2004

(51) Int. Cl. B05D 3/02

(52) U.S. Cl. 427/226

(57) ABSTRACT

A novel method was devised to synthesis an inverted titania crystal on a substrate. At first, a film of surfactant sodium dodecylsulfate (SDS) polystyrene spherical particles was grown on a substrate using Colvin method. Surfactant sodium dodecylsulfate (SDS) stabilizes polystyrene particles and induces necking between the polystyrene particles. Next, the film was dropped inside a Falcon tube that half-filled with a solution comprising Titanium Isopropoxide (TiPT) or Titanium ethoxide (TEOT) diluted with anhydrous ethanol. Then, the Falcon tube was rotated in a centrifuge machine set at 1200-3600 rpm. After 30 minutes the film was removed from the tube and placed inside an anti-static plastic container. The film was stored inside the container for at least 6 hours. This was repeated many times depending on the dilution of the precursor solution (the more diluted the precursor the more the repetition) to fill up voids among the polystyrene colloidal particles. At last, the film was placed inside a tube furnace under airflow with a predetermined ramping temperature setting to remove the polystyrene template and to crystallize titania to its anatase or rutile form. At this stage titania is transformed into a crystalline form. The result of this method is a stable and well-structured inverted titania photonic crystal on a substrate.

This application claims priority from previous provisional application No. 60/448,454 filled in Feb. 21, 2003.

### BACKGROUND OF THE INVENTION

1. Field of the Invention

The present invention relates to novel methods to produce photonic crystals on substrate, and more particularly, to a method for synthesizing an inverted titania opals photonic crystal on substrate.

2. Description of the Previous Published Art

photonic crystals have become one of the most interesting research areas in chemistry and material science engineering for their applications in chemical separation, catalysis, sorption, chromatography, optical sensors, optical waveguids, lasers, future optical circuits, photovoltaic cells (conventional p-n junction solar cells and die-sensitized titania solar cells), battery materials. Three-dimensionally ordered macroporous titania in particular has applications in chemical separation, catalysis, full band gap devices, photonic materials, and solar cells.

Colloidal photonic crystals are materials that have a periodic modulation of low and high refractive index regions with a lattice constant comparable to the wavelength of light. Inverse opals are photonic crystals that have a regular repetition of air which has a lower refractive index of 1 and high refractive index material such as titania which has a refractive index of 2.8 for rutile. Photonic crystals have the property of filtering white light that is depending on their lattice constant they can forbid the propagation of a particular range of wavelengths from propagation through the material, which is reflected instead, and we have a pseudo band-gap there. And the remaining wavelengths can pass through the crystal. In order to have a complete band gap refractive index of the wall should be higher than 2.8. And titania inverse opals fit this description closely. The fabrication of photonic crystals are relatively simple, rapid, and economic.

Some of the applications of the photonic crystals are in optical sensors, optical circuits and waveguids, Laser, Photovoltaic cells (conventional p-n junction solar cells and die-sensitized titania solar cells), catalysis, sorption, chromatography, and battery materials.

Many papers and patents have been written on making ordered macroporous titania opals in powder format but only a handful of scientific papers introduced methods to make such structures on substrate such as glass, fluoride-doped tin oxide (FTO) coated glass, and indium-doped tin oxide (ITO) coated glass.

For example, a method to make macroporous titania opals powder was introduced by Richel and Johnson (Applied Physics Letters, 2000, 76, No. 14, 1816-1818). In this method a polystyrene colloidal crystal powder was assembled on a filter paper. The building blocks of this power are polystyrene spheres of size 400 nm. Then the polystyrene colloidal powder was removed from the filter paper and moved to a nitrogen glove box where it is infiltrated by an alkoxide precursor using a vacuum set up. When the alkoxide precursor soaked completely into the voids of the polystyrene template, the powder is removed from the glove box and let the alkoxide to hydrolyze slowly with the moisture in the air for a few hours. Then to calcine the alkoxide inside the powder and to remove the polystyrene template it is placed in a tube furnace under air flow and heat it 575° C. and stayed at 575° C. for 8 hours. The end-material is an inverse titania opals powder.

First of all, the optical quality of the macroporous titania powder of the last example is not as good as it should be for industry applications. Secondly, the possible applications for these materials are limited because they are not produced on a conductive substrate. Thirdly, the glove box used here is very expensive and adds to the complexity of the process.

One of a very few methods introduced to date on making macroporous titania opals film on substrate was set forth by Kuai and Badilescu (Advanced Materials, 15, No. 1, 2000). In this method silica spheres of the size 309 nm was used to make a silica template on substrate using convective assembly process. Then the film was heated at 600° C. for 1 hour to make necking between silica spheres to increase the film's mechanical stability and to facilitate the template's removal later in the process.

Here they used sol-gel method to infiltrate a silica template. The solution prepared by mixing Titanium tetraisopropoxide (TTIP), Anhydrous ethanol, diethanolamine (DEA), and deionized water with molar ratio of 1:40:0.6:3.3. Silica template was immersed into the sol solution for 5 minutes to infiltrate the sol into voids of the template by a capillary force. Then the template was pulled out of the solution at a rate of 2.5 mm/s with a deep-coating equipment and let it hydrolyze slowly with the air moisture. The authors pointed out that the immersion and the withdrawing speed is very critical to making a good inverse titania opals film. At this stage of process the amorphous titania inside the template voids was densified and crystallized at 520° C. in a tube furnace under air flow. The infiltration and densification steps were repeated for 10 times to fill most of the voids inside the silica The titania-silica composite film on substrate produced in the preceding steps was immersed in a warm template.

(60° C.) aqueous NaOH solution (20%) for 24 hours to remove silica template. The result was an inverse titania opals film on glass microslide.

The macroporous titania film made by Kuai and Badilescu shows a good quality optical properties (transmission deep in its UV-VIS transmission characteristic) and the SEM characteristic of the film shows a long-range order. Of course, the transmission deep here is not sharp which limits its practical photonics application.

One of the main drawbacks of the preceding method to make a inverse titania opal film on glass substrate, as it was mentioned in the paper, was that NaOH solution would weaken the adhesion of the film to the glass substrate which causes the film to be separated from the substrate.

Also, in the preceding method a precise deep-coating immersion and withdraw rate is crucial to the quality of the inverse titania film. In addition, too many steps are involved in making a macroporous titania film on a substrate in this method. These would contribute to the overall high cost of the production.

Obviously, we need a method with fewer steps, with less precision constrains, long rang-order of the film, good adhesion of the film and the substrate, and good quality optical characteristics.

### DETAILED DESCRIPTION OF THE INVENTION

Negatively charged polystyrene particles were stabilized by using surfactant sodium dodecylsulfate (SDS). This increases the mechanical stability of the future template by producing necking between the particles. The increased necking between the particles keep the structure stable during infiltration, and also during the calcinations. These particles were used to make polystyrene opals film on a glass, Indium Tin Oxide (ITO), or Fluorine doped Tin Oxide (FTO) substrate.

A centrifuge tube (Falcon tube) was half-filled with a diluted titanium precursor such as titanium (iv) isopropoxide (TiPT), or titanium ethoxide (TEOT) with anhydrous ethanol. Then the polystyrene template was dropped into the Falcon tube vertically. The degree of dilution is crucial to keep the structure of the template intact. After trying different dilution percentages it was obvious that dilution factors of less than 4 V % had little destructive effect on the polystyrene templates.

The centrifuge speed dial was set at 1200 rpm to 3600 rpm depending on the size of the centrifuge equipment. Basically, the smaller the machine is the faster it should turn to produce same gravitational effect. And it was kept turning for 30 to 60 minutes.

After each centrifuge step was done, the film was taken out of the tube and placed in a loosely closed container. The infiltrated template was stored in the container for at least 6 hours. This resting period is necessary to let the precursor to hydrolyze and form an amorphous titania inside the voids of the polystyrene template. Then the template is put inside the Falcon tube and it is gone through another centrifuge step.

Based on my results the number of the centrifuge step repetitions was at least 5 times to produce a stable and well ordered inverse titania film on a substrate when a dilution factor of 4 V % of precursor was used. Of course, one could repeat the infiltration step until almost all the voids inside the template were filled with the titania. This could be figured out by following UV-VIS characteristics in particular the wavelength of the stop band on the absorption spectrum as it moved to higher wavelengths (red-shift) with each infiltration step. This is found from the light absorption against wavelength plot produced by a UV-VIS spectrophotometer. When this peak does not move to higher bandwidths anymore it mean all voids inside the template is almost filled.

The UV-VIS characterization of the films indicated the following. The higher the concentrations of the solutions were the faster the degradation of the films (smaller stop-band peak). At the same time the more concentrated the solution was the higher the red-shift jump resulted for the film. So to optimize the infiltration the concentration should be very low. As mentioned above concentrations of 4 V % (4 volume percent) and lower gave very good results.

After the last step we have a film that comprised of polystyrene template and titania particles that are not crystallized.

Therefore, in order to crystallize the titania and remove the polystyrene template, the infiltrated film is placed inside a tube furnace under airflow and heated as follows:
a) Starting from room temperature (25° C.), the film is heated gradually at the rate of 0.46° C./min to 80° C.;
b) Temperature stayed at 80° C. for an hour;
c) Temperature was increased from 80° C. to 450° C. at a rate of 2.06° C./min;
d) Temperature remained at 450° C. for 3 hours;
e) At the end it is allowed to cool down back to room temperature.

This heating procedure is needed for two reasons, first to remove the latex through gasifying and burning (evaporating temperature (350° C.) of polystyrene is much lower than the crystallization temperature of titania), and second to convert the amorphous titania to crystalline anatase form of titania.

The result of this procedure is an inverted titania photonic crystal on a substrate such as glass, ITO, or FTO coated glass.

The parts that are unique in this invention are as follows:
1) Using centrifugation as a method to infiltrate uniformly from top to bottom inside the polystyrene template on a substrate;
2) Taking low concentrations (less than 4V %) of alkoxides to infiltrate polystyrene template with repetitions so keeping the voids openings of the template open for more infiltration steps;
3) Ability to repeat infiltration of the template uniformly many times;
4) Using negatively charged surfactant stabilized polystyrene spheres with sulfate functional group to make a photonic crystal template on substrate to produce necking between the particles. The necking would benefit the resulting inverse titania film in two ways; it stabilizes the template during infiltration and then during calcination and removal of the template.

### BRIEF DESCRIPTION OF THE DRAWINGS

FIG. 1 shows the absorption spectrum determined at normal incidence to the macroporous titania inverse opal film.

FIG. 2 is the scanning electron microscopy image of the cross-section of the macroporous titania inverse opal film on substrate.

### DETAILED DESCRIPTION OF THE DRAWINGS

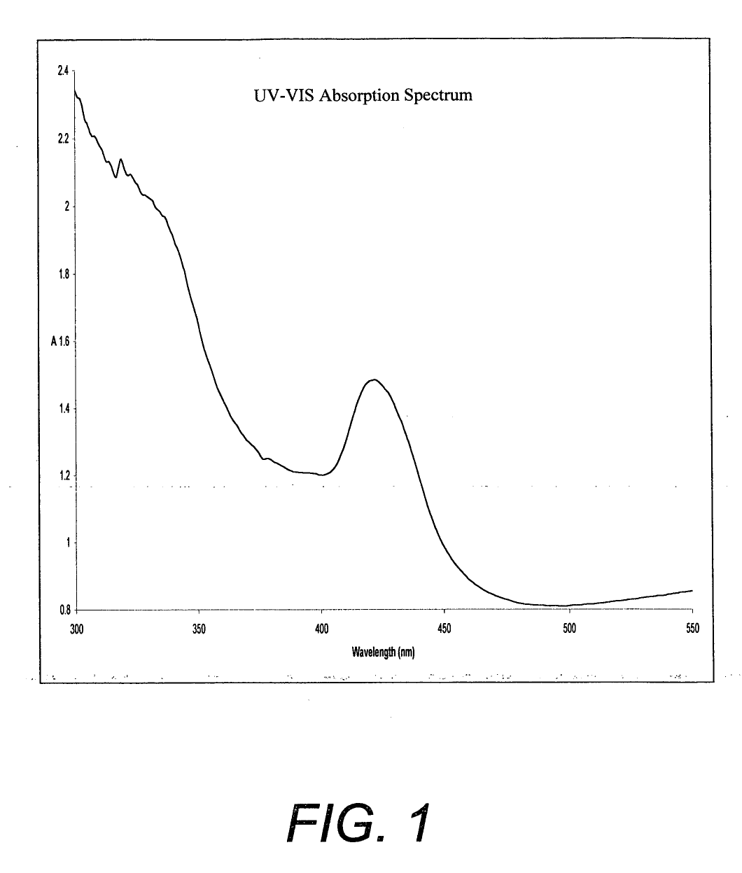

FIG. 1 shows the absorption spectrum determined at normal incidence of the macroporous titania inverse opal film produced by following closely the steps in the claim section. The significant sharp transmission dip at 425 nm is the pseudo-band gap resulted from Bragg diffraction from (111) planes of the titania inverse opal structure. The sharpness of the absorption peak is an indication of strong photonic band gap properties of the film and, in turn, an indication of high quality optical characteristic of the film.

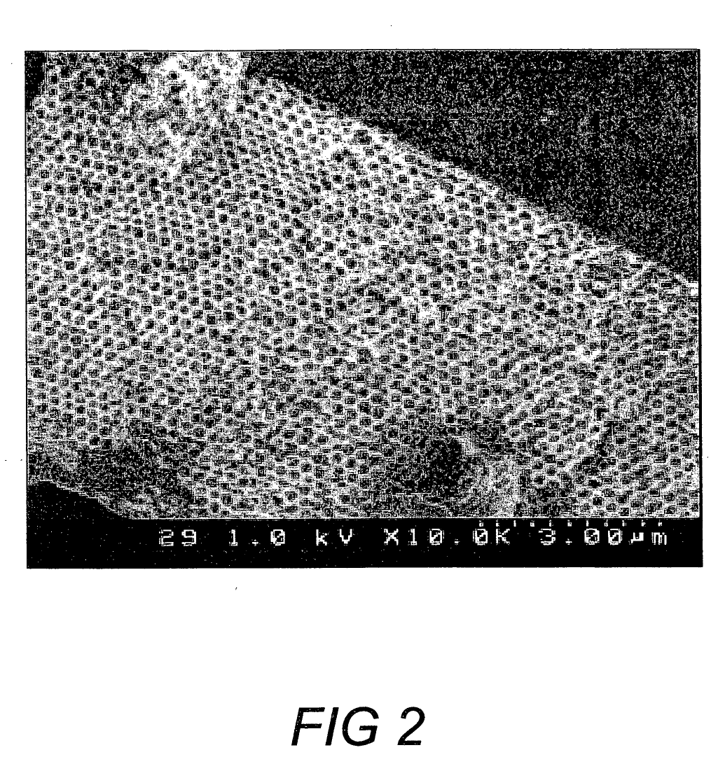

FIG. 2 is the scanning electron microscopy image of the cross-section of the macroporous titania inverse opal film on substrate. From the highly ordered hexagonal arrangement of the pores from the top layer to the bottom is an indication of the successful uniform infiltration of whole film. The cross-section image is also an indication of successful removal of the polystyrene template from top to the bottom of the film. The high quality and long range order can be seen by drawing a virtual diagonal line on the pores from top to the bottom.

1. A method of making a macroporous titania opals film on a substrate, comprising the steps of:
a) Preparing a diluted solution of Titanium alkoxides precursor in anhydrous ethanol;
b) Dropping a polystyrene colloidal crystal template film on substrate vertically into a Falcon tube half-filled with said solution;
c) Circulating Falcon tube using a centrifuge instrument;
d) Removing said film from said Falcon tube and placing said film in a loosely closed container to slowly hydrolyze Titanium alkoxide sol inside said template;
e) Repeat said steps b to d for 5 to 7 times to fill the voids of said film;
f) Heating the hydrolyzed said film to calcine amorphous titania and convert said titania to anatase or rutile format and, in the process, gasify and burn the polystyrene template.

2. The method as specified in claim 1 wherein said polystyrene colloids are surfactant stabilized with sulfate functional group.

3. The method as specified in claim 1 wherein the precursor compound comprises Titanium Isopropoxide (TiPT) or Titanium ethoxide (TEOT).

4. The method as specified in claim 1 wherein the concentration of said precursor alkoxide (TiPT or TEOT) is between 0.8 V % and 4 V %.

5. The method as specified in claim 1 wherein said centrifuge rotating speed is between 1200 rpm to 3600 rpm.

6. The method as specified in claim 1 wherein said centrifuge instrument ran for 30 minutes to an hour.

7. The method as specified in claim 1 wherein the infiltrated template when removed from the Falcon tube and placed said film in a loosely closed container to slowly hydrolyze Titanium alkoxide said sol inside the template for 3 to 6 hours.

8. The method as specified in claim 1 wherein said heating was done in a tube furnace under airflow and was controlled as follows:
a) Temperature was increased from room temperature (25° C.) to 80° C. at a rate of 0.46° C./min;
b) Temperature stayed at 80° C. for an hour;
c) Temperature was increased from 80° C. to 450° C. at a rate of 2.06° C./min;
d) Temperature remained at 450° C. for 3 hours;
e) The furnace was turned off and let said film to cool down to room temperature.
